(19) United States
(12) Patent Application Publication
(10) Pub. No.: US 2019/0200357 A1
(43) Pub. Date: Jun. 27, 2019

(54) WIRELESS COMMUNICATION DEVICE

(71) Applicant: Murata Manufacturing Co., Ltd., Kyoto (JP)

(72) Inventors: Koudai YOKOTE, Kyoto (JP); Hiroyuki NIWA, Kyoto (JP); Toshihiro HOSOKAWA, Kyoto (JP); Suguya IBARAKI, Kyoto (JP); Takuya KIDERA, Kyoto (JP); Takayuki HORIBE, Kyoto (JP); Ryuhei NAKAI, Kyoto (JP); Nobumitsu AMACHI, Kyoto (JP)

(21) Appl. No.: 16/286,972

(22) Filed: Feb. 27, 2019

Related U.S. Application Data
(63) Continuation of application No. PCT/JP2017/029929, filed on Aug. 22, 2017.

(30) Foreign Application Priority Data
Aug. 31, 2016 (JP) 2016-169966

(51) Int. Cl. H04W 72/04

(52) U.S. Cl. CPC H04W 72/0453

(57) ABSTRACT

A wireless communication device (50) includes a housing (51) and a first board (52) placed inside the housing (51). On the first board (52) there is mounted a first communication circuit (61a) and a first antenna (61b) that perform wireless communication based on a first wireless communication system that uses a first frequency band and a second communication circuit (62a) and a second antenna (62b) that perform wireless communication based on a second wireless communication system that uses the first frequency band and is different from the first wireless communication system. The first antenna (61b) and the second antenna (62b) are respectively placed in a first region and a second region that are in a diagonal spatial relationship in plan view of the first board (52).

### BACKGROUND OF THE DISCLOSURE

This is a continuation of International Application No. PCT/JP2017/029929 filed on Aug. 22, 2017 which claims priority from Japanese Patent Application No. 2016-169966 filed on Aug. 31, 2016. The contents of these applications are incorporated herein by reference in their entireties.

### FIELD OF THE DISCLOSURE

The present disclosure relates to wireless communication devices and, more particularly, to a wireless communication device that performs wireless communication based on a plurality of different wireless communication systems that use the same frequency band.

### DESCRIPTION OF THE RELATED ART

Wireless communication devices that perform wireless communication based on a plurality of different wireless communication systems have been proposed to meet a variety of wireless communication usage (for example, see Non-patent document 1).

Non-patent document 1 discloses a gateway compatible with two types of wireless communication systems, Wireless LAN (Wi-Fi (Registered trademark)) and Bluetooth (Registered trademark). Such gateway allows connection with devices compatible with wireless LAN as well as devices compatible with Bluetooth (Registered trademark).

Non-Patent Document 1: Ishibashi, Yasuhiro and two others (2002) “Wireless LAN Broadband Gateway Series WBG-1000, 1200”, Toshiba Review, Vol. 57, No. 10, pp. 28-32.

### BRIEF SUMMARY OF THE DISCLOSURE

In the gateway disclosed in the foregoing Non-patent document 1, however, there is an issue that a plurality of different wireless communication systems that use the same frequency band cannot be used together (used simultaneously) or when used together, smooth communication cannot be obtained. In other words, in the gateway disclosed in the foregoing Non-patent document 1, smooth communication cannot be obtained when wireless communication by Wi-Fi (Registered trademark) and wireless communication by Bluetooth (Registered trademark) are used together at the same frequency band. This is because radio wave interference causes Intra-channel interference where another station's signal directly enters a reception band to cause reception errors or Inter-channel interference where distortion or the like caused by reception of out-of-band noise of another station's signal or reception of another station's signal itself causes reception errors, or often causes the carrier sense where transmission of its own signal is suppressed (losing transmission opportunity) upon detection of another station's signal.

In recent years, various wireless communication systems are widely used. For example, the 2.4 GHz band is used in wireless communication systems such as Wi-Fi (Registered trademark), Bluetooth (Registered trademark), ZigBee (Registered trademark), and the like. There is demand for wireless communication devices that can perform smooth wireless communication based on at least two of the wireless communication systems simultaneously, which use this 2.4 GHz band, from among the wireless communication systems such as Wi-Fi (Registered trademark), Bluetooth (Registered trademark), ZigBee (Registered trademark), and the like. In wireless communication systems such as Wi-SUN (Registered trademark), EnOcean (Registered trademark), LoRa (Registered trademark), Sigfox (Registered trademark), and the like, the 800/900 MHz band (920 MHz band in Japan) is used. There is a demand for wireless communication devices that can perform smooth wireless communication based on at least two of the wireless communication systems simultaneously, which use this frequency band, from among the wireless communication systems such as Wi-SUN (Registered trademark), EnOcean (Registered trademark), LoRa (Registered trademark), Sigfox (Registered trademark), and the like.

Conventional wireless communication devices cannot use wireless communication based on a plurality of different wireless communication systems together, which use the same frequency band, or cannot perform smooth wireless communication based on a plurality of wireless communication systems simultaneously. This raises an issue that the conventional wireless communication device cannot be used in many usage cases such as, for example, receiving an operation instruction from a smartphone via wireless LAN based on Wi-Fi (Registered trademark) while controlling a lighting apparatus using wireless communication based on ZigBee (Registered trademark).

Accordingly, an object of the present disclosure is to provide a wireless communication device capable of performing smooth wireless communication based on a plurality of different wireless communication systems simultaneously, which use the same frequency band.

In order to achieve the foregoing object, a wireless communication device according to one aspect of the present disclosure includes a housing; and a first board placed inside the housing, wherein a first communication circuit and a first antenna that perform wireless communication based on a first wireless communication system that uses a first frequency band and a second communication circuit and a second antenna that perform wireless communication based on a second wireless communication system that uses the first frequency band are mounted on the first board, the second wireless communication system being different from the first wireless communication system, and the first antenna and the second antenna are respectively placed in a first region and a second region that are in a diagonal spatial relationship in plan view of the first board.

Because of this, the first antenna and the second antenna, which are compatible with a plurality of different wireless communication systems that use the same frequency band, are respectively placed in the first region and the second region that are in a diagonal spatial relationship in plan view of the first board to be placed at locations separate from each other, thereby suppressing radio wave interference between the wireless communication using the first antenna and the wireless communication using the second antenna. As a result, it becomes possible to perform smooth wireless communication based on a plurality of different wireless communication systems simultaneously, which use the same frequency band. Because of the suppression of radio wave interference, the retransmission rate during wireless communication caused by the interference is also suppressed, thereby reducing electric power consumption associated with the retransmission.

Here, the first antenna and the second antenna may be arranged on the first board in such a way that principal radiation directions of the first antenna and the second antenna are orthogonal to each other.

Because of this, the principal radiation direction of the first antenna and the principal radiation direction of the second antenna that use the same frequency band are orthogonal to each other, and this enables further suppression of the radio wave interference between the wireless communication that uses the first antenna and the wireless communication that uses the second antenna, thereby realizing the wireless communication device having good reception.

A third communication circuit and a third antenna that perform wireless communication based on a third wireless communication system that uses a second frequency band, the second frequency band being different from the first frequency band, and a fourth communication circuit and a fourth antenna that perform wireless communication based on a fourth wireless communication system that uses the second frequency band, the fourth wireless communication system being different from the third wireless communication system, may be further mounted on the first board, and the third antenna and the fourth antenna may respectively be arranged in a third region and a fourth region that are in a diagonal spatial relationship in plan view of the first board, each of the third region and the fourth region being different from both the first region and the second region.

Because of this, as with the first antenna and the second antenna, the third antenna and the fourth antenna, which are compatible with the different wireless communication systems that use the second frequency band different from the first frequency band, respectively arranged in the third region and the fourth region that are in the diagonal spatial relationship in plan view of the first board to be placed at locations separate from each other, thereby suppressing radio wave interference between the wireless communication using the third antenna and the wireless communication using the fourth antenna. Accordingly, it becomes possible to perform smooth wireless communication based on two sets of two types of different wireless communication systems, namely, four types of wireless communication systems simultaneously, which use the same frequency band.

The third antenna and the fourth antenna may be arranged on the first board in such a way that principal radiation directions of the third antenna and the fourth antenna are orthogonal to each other.

Because of this, as with the first antenna and the second antenna, the principal radiation direction of the third antenna and the principal radiation direction of the fourth antenna that use the same frequency band are orthogonal to each other, and this enables further suppression of the radio wave interference between the wireless communication that uses the third antenna and the wireless communication that uses the fourth antenna, thereby realizing the wireless communication device having good reception.

Of communication circuits and antennas mounted on the first board, the first communication circuit and the first antenna may perform communication using a widest frequency band or perform most frequent communication, and of the communication circuits and the antennas mounted on the first board, the third communication circuit and the third antenna may be mounted at a location closest to the first communication circuit and the first antenna and arranged on a second plane whose height from the first board is different from that of a first plane on which the first communication circuit and the first antenna are mounted.

Because of this, the first communication circuit and the first antenna, which perform communication using a widest frequency band or perform most frequent communication in the communication circuits and antennas mounted on the first board, and the third communication circuit and the third antenna, which are mounted at a location closest to the first communication circuit and the first antenna, are placed at the planes of different heights. Thus, compared with a case where the first communication circuit and the first antenna and the third communication circuit and the third antenna are placed on the same plane, out-of-band radio wave interference between the wireless communication using the first communication circuit and the first antenna and the wireless communication using the third communication circuit and the third antenna is suppressed.

The first plane may be a principal surface of the first board, and the second plane may be a principal surface of the second board connected to the first board using a board joining connector.

Because of this, the first communication circuit and the first antenna and the third communication circuit and the third antenna are placed on different boards, which are connected using the board joining connector, and these boards are detachable. Thus, a combination of boards to be used together can be changed easily, thereby making it possible to flexibly meet various needs.

The third wireless communication system may be a wireless communication system of a type in which a frequency band to be used or a wireless communication system to be used or both are different depending on a delivery destination of the wireless communication device.

Because of this, the second board on which the third communication circuit and the third antenna are arranged is connected to the first board using the board joining connector. Thus, by replacing the second board with a type of board suitable in a delivery destination of the wireless communication device, the wireless communication device that meets specifications of the delivery destination can be manufactured without difficulty.

A shield case that houses an electric power supply circuit, a logic circuit, and at least one of the electric power supply circuit and the logic circuit therein may be further mounted on the first board; the shield case may have a contour including an interior angle larger than 180 degrees in plan view of the first board; an opening may be formed at a side surface corresponding to the interior angle of the shield case; and each of the first communication circuit, the first antenna, the second communication circuit, and the second antenna may be arranged on the first board at such a location that is out of sight when viewed outside through the opening from inside the shield case.

Because of this, despite the presence of the opening in the shield case introduced for downsizing and increasing the level of integration, stable communication is obtained because the first communication circuit and the first antenna and the second communication circuit and the second antenna are placed at locations where the first communication circuit and the first antenna and the second communication circuit and the second antenna are less likely to come under the influence of the electromagnetic wave noise leaked from the opening.

The first antenna and the second antenna may be arranged along a side of the first board in plan view of the first board; an external device connector for connecting the wireless communication device and an external device may further be mounted on the first board, the external device being placed outside the housing and performing wireless communication based on a wireless communication system that is different from both the first wireless communication system and the second wireless communication system; and the external device connector may be arranged along a side of the first board that is different from both the side of the first board along which the first antenna is arranged and the side of the first board along which the second antenna is arranged.

Because of this, the external device connector, which is for connecting with an external device that performs wireless communication based on a wireless communication system different from the wireless communication systems employed in the wireless communication device, is placed at the location where interference with the wireless communication using the first antenna and interference the wireless communication using the second antenna are less likely to occur, thereby enabling stable wireless communication using the external device added by use of the external device connector.

The present disclosure enables the realization of the wireless communication device capable of performing smooth wireless communication based on a plurality of different wireless communication systems simultaneously, which use the same frequency band.

### BRIEF DESCRIPTION OF THE SEVERAL VIEWS OF THE DRAWINGS

FIG. 1 is a diagram illustrating an application example of a wireless communication device according to an embodiment.

FIG. 2 is a mounting layout diagram illustrating a configuration of the wireless communication device illustrated in FIG. 1.

FIG. 3 is a block diagram illustrating a connection relationship between various circuit elements illustrated in FIG. 2.

FIG. 4 is a diagram illustrating one example of a development diagram of a shield case illustrated in FIG. 1.

FIG. 5 is a mounting layout diagram illustrating a configuration of a wireless communication device according to a modified example of an embodiment.

FIG. 6 is a block diagram illustrating a connection relationship between various circuit elements illustrated in FIG. 5.

FIG. 7 is a diagram illustrating a mounting example of a communication circuit and an antenna in a first board having an L-shape.

### DETAILED DESCRIPTION OF THE DISCLOSURE

Hereinafter, embodiments of the present disclosure will be described in detail with reference to the drawings. Note that the embodiments which will be described below each illustrate a specific example of the present disclosure. Numeric values, frequency bands, wireless communication systems, shapes, materials, constituting elements, arrangement locations and connection modes of the constituting elements, processing procedures, and the like are mere examples, and not intended to limit the present disclosure. Of constituting elements in the following embodiments, the constituting elements that are not described in the independent claim representing the broadest concept of the present disclosure will be described as optional constituting elements.

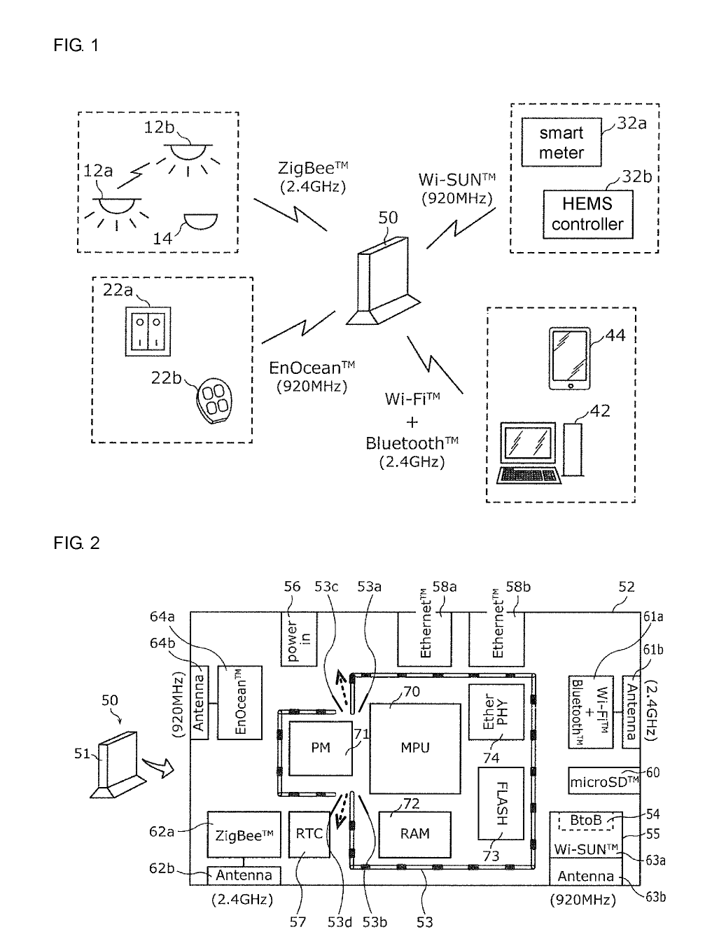

FIG. 1 is a diagram illustrating an application example of a wireless communication device 50 according to an embodiment. Here, the wireless communication device 50 is illustrated as a device that functions as a gateway that uses wireless communication based on the total of four types of wireless communication systems together and also as a device controller for controlling various devices, the four types of wireless communication systems including wireless LAN (Wi-Fi (Registered trademark)) and Bluetooth (Registered trademark) that can be selectively used and are examples of a first wireless communication system that uses the 2.4 GHz band, which corresponds to a first frequency band, ZigBee (Registered trademark) that is an example of a second wireless communication system that uses the 2.4 GHz band, which corresponds to the same first frequency band, Wi-SUN (Registered trademark) that is an example of a third wireless communication system that uses the 920 MHz band, which corresponds to a second frequency band, and EnOcean (Registered trademark) that is an example of a fourth wireless communication system that uses the 920 MHz band, which corresponds to the same second frequency band.

Specifically, lighting apparatuses 12a and 12b form a ZigBee (Registered trademark) mesh network, and the wireless communication device 50 functions as a coordinator thereof. Battery-operated illuminance sensors 14 are installed at many indoor locations, and their data are also aggregated at the wireless communication device 50 via the ZigBee (Registered trademark) mesh network.

Light switches 22a and 22b that use an energy harvesting power supply by EnOcean (Registered trademark) are installed inside a room, and the transmission data from these light switches 22a and 22b are received with the wireless communication device 50.

A smart meter 32a and a Home Energy Management System (HEMS) controller 32b are connected to the wireless communication device 50 based on Wi-SUN (Registered trademark), and the wireless communication device 50 continuously monitors electric power usage and transmits demand-response information such as shortage of electric power supply or the like via B route or the like. The wireless communication device 50 performs, based on this demand-response information, an energy saving control such as turning off indoor lighting at a location where a motion sensor outputs no response.

A smartphone 44 and the wireless communication device 50 are connected to each other based on Bluetooth (Registered trademark), and this enables the smartphone 44 to control lighting using a lighting control application. Further, a personal computer (PC) 42 and the smartphone 44 can access a setup screen (Web control) of the wireless communication device 50 based on Wi-Fi (Registered trademark) to set the lighting control or check usage thereof.

FIG. 2 is a diagram illustrating the configuration of the wireless communication device 50 illustrated in FIG. 1. Here, a mounting layout of circuit boards (first board 52 and second board 55) placed inside a housing 51 included in the wireless communication device 50 is illustrated.

The following four sets of communication circuits and antennas are mounted on the first board 52; a first communication circuit 61a and a first antenna 61b that perform wireless communication based on Wi-Fi (Registered trademark) and Bluetooth (Registered trademark) that can be used selectively and both use the 2.4 GHz band; a second communication circuit 62a and a second antenna 62b that perform wireless communication based on ZigBee (Registered trademark) that uses the 2.4 GHz band; a third communication circuit 63a and a third antenna 63b that perform wireless communication based on Wi-SUN (Registered trademark) that uses the 920 MHz band; and a fourth communication circuit 64a and a fourth antenna 64b that perform wireless communication based on EnOcean (Registered trademark) that uses the 920 MHz band. Here, the first communication circuit 61a is a combo chip compatible with wireless communication systems of Wi-Fi (Registered trademark) and Bluetooth (Registered trademark), which use a single band of the 2.4 GHz band. The third communication circuit 63a and the third antenna 63b are placed on the second board 55, which serves as a sub board and is connected to the first board 52, which serves as a main board, using a board joining connector (B to B) 54. Note that the first antenna 61b, the second antenna 62b, the third antenna 63b, and the fourth antenna 64b may be wiring patterns formed on a principal surface (namely, a surface on which circuit components are mounted) of the first board 52 or the second board 55, or conductors formed so as to stand up from the board, or mixtures of the wiring pattern and the conductor. The first board 52 has a rectangular contour in the present embodiment. However, the shape is not limited only to such contour as described below.

On the first board 52, as logic circuits, a micro-processing unit (MPU) 70, a RAM 72, a flash memory 73, an ethernet (Registered trademark) IC (Ether PHY) 74, and a real time clock (RTC) 57 are mounted, and as an electric power supply circuit, an electric power management IC (PM) 71 is mounted. Here, the MPU 70, the electric power management IC 71, the RAM 72, the Flash memory 73, and the ethernet (Registered trademark) IC 74 are placed inside the shield case 53 having a lidded structure to suppress unwanted electromagnetic wave noise toward communication circuits in the surrounding area. The details of the shield case 53 will be described below.

Further, on the first board 52, as connectors of various types for connecting to an electric power supply or an external device, an electric power supply terminal (power in) 56, an ethernet (Registered trademark) ports 58a and 58b, and a microSD (Registered trademark) 60 are mounted.

Note that, in the present specification, “mounted (or placed) on a board” means not only a case where a component is directly mounted (or placed) on the board, but also includes a case where a component is indirectly mounted (or placed) on the board using another component such as the board joining connector 54 or the like.

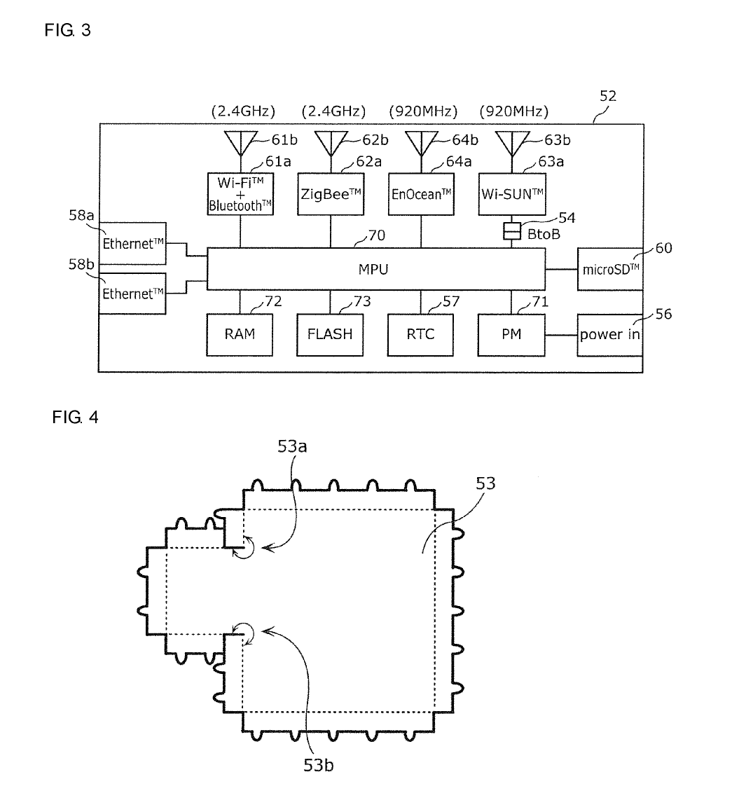

FIG. 3 is a block diagram illustrating a connection relationship between various circuit elements mounted on the first board 52 and the second board 55 illustrated in FIG. 2. As illustrated in the drawing, the first communication circuit 61a, the second communication circuit 62a, the fourth communication circuit 64a, the ethernet (Registered trademark) ports 58a and 58b, the RAM 72, the flash memory 73, the real time clock 57, the electric power management IC 71, and the microSD (Registered trademark) 60 are connected to the MPU 70, and the third communication circuit 63a is connected to the MPU 70 using the board joining connector 54.

The electric power management IC 71 receives an externally-supplied DC electric power via the electric power supply terminal 56, generates DC voltages of various types required in the wireless communication device 50 at appropriate timings, and supplies the generated DC voltages to circuit elements of various types. The ethernet (Registered trademark) ports 58a and 58b are used as WAN ports for connecting with the internet outside or LAN ports forming a home network, or are used as LAN HUB.

The MPU 70 includes a ROM in which a control program is stored, a processor that executes the control program, and the like. When the processor executes the control program, the processor sends and receives data and control signals to and from circuit elements of various types connected to the MPU 70, thereby making the wireless communication device 50 function as the gateway and the device controller illustrated in FIG. 1.

The wireless communication device 50 in the present embodiment configured as described above has the following characteristic features.

The first antenna 61b for Wi-Fi (Registered trademark) and Bluetooth (Registered trademark) that use the 2.4 GHz band and the the second antenna 62b for ZigBee (Registered trademark) that uses the same 2.4 GHz are placed in a first region and a second region of the first board 52, respectively, wherein the first region and the second region are in a diagonal spatial relationship in plan view of the first board 52. In the present embodiment, as illustrated in FIG. 2, the first antenna 61b is placed in an upper right region (first region) of the first board 52 whereas the second antenna 62b is placed in a lower left region (second region) of the first board 52.

Because of this, the first antenna 61b and the second antenna 62b, which are compatible with a plurality of different wireless communication systems that use the same frequency band, are placed at locations separate from each other. Accordingly, radio wave interference is suppressed between the wireless communication by Wi-Fi (Registered trademark) and Bluetooth (Registered trademark) that use the first antenna 61b and the wireless communication by ZigBee (Registered trademark) that uses the second antenna 62b. As a result, it becomes possible to perform smooth wireless communication based on the plurality of different wireless communication systems (Wi-Fi (Registered trademark) and Bluetooth (Registered trademark) and ZigBee (Registered trademark)) simultaneously, which use the same frequency band. Because of the suppression of the radio wave interference, the first board 52 can be made smaller in size compared with that of the prior art, thereby making it possible to make the wireless communication device 50 smaller in size and higher in integration level. Further, because of the suppression of the radio wave interference, the retransmission rate during wireless communication caused by the interference is also suppressed, thereby reducing the electric power consumption associated with the retransmission.

The same thing as with the first antenna 61b and the second antenna 62b can be said with the third antenna 63b and the fourth antenna 64b. In other words, the third antenna 63b for Wi-SUN (Registered trademark) that uses the 920 MHz band and the the fourth antenna 64b for EnOcean (Registered trademark) that uses the same 920 MHz are placed in a third region and a fourth region, respectively, wherein the third region and the fourth region are each different from both the first region and the second region and are in the diagonal spatial relationship in plan view of the first board 52. In the present embodiment, as illustrated in FIG. 2, the third antenna 63b is placed in a lower right region (third region) of the first board 52 whereas the fourth antenna 64b is placed in an upper left region (fourth region) of the first board 52.

Because of this, the third antenna 63b and the fourth antenna 64b, which are compatible with a plurality of different wireless communication systems that use the same frequency band, are placed at separate locations from each other, as with the first antenna 61b and the second antenna 62b. Accordingly, radio wave interference is suppressed between the wireless communication by Wi-SUN (Registered trademark) that uses the third antenna 63b and the wireless communication by EnOcean (Registered trademark) that uses the fourth antenna 64b. As a result, it becomes possible to perform smooth wireless communication based on the plurality of different wireless communication systems (Wi-SUN (Registered trademark) and EnOcean (Registered trademark)) simultaneously, which use the same frequency band. Because of the suppression of the radio wave interference, the first board 52 can be made smaller in size compared with that of the prior art, thereby making it possible to make the wireless communication device 50 smaller in size and higher in integration level. Further, because of the suppression of the radio wave interference, the retransmission rate during wireless communication caused by the interference is also suppressed, thereby reducing the electric power consumption associated with the retransmission.

Note that in the present specification “two regions that are in a diagonal spatial relationship” may be, in plan view of the first board 52, regions within a predetermined range (for example, a distance corresponding to 10% of the diagonal line) from respective ones of two vertices of the first board 52 that are in the diagonal spatial relationship, or may means that, of the antennas mounted on the first board 52, antennas are placed at locations closest to respective ones of these two vertices, or may be regions along the sides of the first board 52 that are connected to respective ones of these two vertices.

The first antenna 61b for Wi-Fi (Registered trademark) and Bluetooth (Registered trademark) that use the 2.4 GHz band and the the second antenna 62b for ZigBee (Registered trademark) that uses the same 2.4 GHz are arranged on the first board 52 in such a way that principal radiation directions thereof are orthogonal to each other. In the present embodiment, as illustrated in FIG. 2, the first antenna 61b is placed in such a manner as to extend along the right-hand side of the first board 52 having a rectangle contour whereas the second antenna 62b is placed in such a manner as to extend along the bottom side of the first board 52. As a result, the principal radiation directions of the first antenna 61b and the second antenna 62b are orthogonal to each other.

Because of this, the principal radiation direction of the first antenna 61b and the principal radiation direction of the second antenna 62b that use the same frequency band are orthogonal to each other, and the radio wave interference is further suppressed between the wireless communication by Wi-Fi (Registered trademark) and Bluetooth (Registered trademark) that use the first antenna 61b and the wireless communication by ZigBee (Registered trademark) that uses the second antenna 62b, thereby realizing the wireless communication device 50 having good reception.

The same thing as with the first antenna 61b and the second antenna 62b can be said with the third antenna 63b and the fourth antenna 64b. In other words, the third antenna 63b for Wi-SUN (Registered trademark) that uses the 920 MHz band and the the fourth antenna 64b for EnOcean (Registered trademark) that uses the same 920 MHz are arranged on the first board 52 in such a way that principal radiation directions thereof are orthogonal to each other. In the present embodiment, as illustrated in FIG. 2, the third antenna 63b is placed in such a manner as to extend along the bottom side of the first board 52 having a rectangle contour whereas the fourth antenna 64b is placed in such a manner as to extend along the left-hand side of the first board 52. As a result, the principal radiation directions of the third antenna 63b and the fourth antenna 64b are orthogonal to each other.

Because of this, as with the first antenna 61b and the second antenna 62b, the principal radiation direction of the third antenna 63b and the principal radiation direction of the fourth antenna 64b that use the same frequency band are orthogonal to each other, and the radio wave interference is further suppressed between the wireless communication by Wi-SUN (Registered trademark) that uses the third antenna 63b and the wireless communication by EnOcean (Registered trademark) that uses the fourth antenna 64b, thereby realizing the wireless communication device 50 having good reception.

Note that, in the present specification, “orthogonal” refers to a state where directions are substantively orthogonal to the extent that the suppression of radio wave interference is effective, and also includes a state where directions cross at an angle of 80 to 100 degrees, for example.

A communication circuit and an antenna (in this case, the third communication circuit 63a and the third antenna 63b that perform wireless communication by Wi-SUN (Registered trademark) that uses the 920 MHz band) mounted at a location closest to the the first communication circuit 61a and the first antenna 61b are placed on a second plane (in this case, the principal surface of the second board 55) whose height from the first board 52 is different from that of a first plane (in this case, the principal surface of the first board 52) on which the first communication circuit 61a and the first antenna 61b are mounted, wherein the first communication circuit 61a and the first antenna 61b perform wireless communication by Wi-Fi (Registered trademark), which use the widest frequency band in the communication circuits and antennas mounted on the first board 52 or perform most frequent wireless communication in the communication circuits and antennas mounted on the first board 52. In other words, the third communication circuit 63a and the third antenna 63b that perform wireless communication by Wi-SUN (Registered trademark) that uses the 920 MHz band are not on-board mounted on the first board 52, but are mounted as a built-in antenna module (module including the second board 55) to be connected to the first board 52 using the board joining connector 54.

Wi-Fi (Registered trademark) and Wi-SUN (Registered trademark) use different frequency bands. However, since communication by Wi-Fi (Registered trademark) uses large bandwidth and is performed highly frequently, there is a possibility of causing out-of-band interference at a communication circuit and an antenna placed close to the first communication circuit 61a and the first antenna 61b that perform wireless communication by Wi-Fi (Registered trademark) on the first board 52. Accordingly, in the present embodiment, the first communication circuit 61a and the first antenna 61b and the third communication circuit 63a and the third antenna 63b, which are mounted at a location closest to the first communication circuit 61a and the first antenna 61b, are placed at the planes of different heights. Accordingly, compared with a case where the first communication circuit 61a and the first antenna 61b and the third communication circuit 63a and the third antenna 63b are placed on the same plane, out-of-band radio wave interference is suppressed between the wireless communication using the first communication circuit 61a and the first antenna 61b (namely, wireless communication by Wi-Fi (Registered trademark) and Bluetooth (Registered trademark) that use the 2.4 GHz band) and the wireless communication using the third communication circuit 63a and the third antenna 63b (namely, wireless communication by Wi-SUN (Registered trademark) that uses the 920 MHz band).

The first communication circuit 61a and the first antenna 61b and the third communication circuit 63a and the third antenna 63b are placed on different boards, which are connected using the board joining connector 54, and these boards are detachable. Thus, a combination of boards to be used together can be changed easily, thereby making it possible to flexibly meet various needs.

On the first board 52, the shield case 53 that houses at least one of the electric power supply circuit and the logic circuits therein is mounted. The shield case 53 has a contour including interior angles 53a and 53b larger than 180 degrees in plan view of the first board 52, and openings 53c and 53d are formed at side surfaces corresponding to the interior angles 53a and 53b of the shield case 53, respectively. The first communication circuit 61a and the first antenna 61b, the second communication circuit 62a and the second antenna 62b, the third communication circuit 63a and the third antenna 63b, and the fourth communication circuit 64a and the fourth antenna 64b are each placed on the first board 52 at such a location that is out of sight when viewed outside through the opening 53c or 53d from inside the shield case 53. Here, “out of sight” when viewed outside from inside the shield case 53 means the spatial relationship such that the communication circuits and the antennas do not receive direct radiation of electromagnetic wave noise leaked from the opening 53c or 53d, and also includes cases where other circuit components are present between the openings 53c and 53d and the communication circuits and the antennas.

Specifically, the shield case 53 is molded from a solid plate of nickel silver or the like by use of inexpensive punching and bending processing, as illustrated in a development diagram illustrated in FIG. 4. The shield case 53 is fixed by soldering after inserting its nail portions into through holes formed in the first board 52 while covering the logic circuits such as the MPU 70, the electric power management IC 71, the RAM 72, the Flash memory 73, and the ethernet (Registered trademark) IC 74. Here, the shield case 53 has a protruded plane shape (namely, the interior angles 53a and 53b larger than 180 degrees are present in the contour in plan view), and therefore, partial gaps (openings 53c and 53d) are formed at the side surfaces of inner side corners (see FIG. 2). In the present embodiment, the openings 53c and 53d are directed to (open toward) the electric power supply terminal 56 and the real time clock 57. This suppresses, at each of four types of communication circuits and antennas, the direct radiation of the electromagnetic wave noise leaked from the openings 53c and 53d.

Because of this, despite the presence of the openings in the shield case 53 introduced for downsizing and increasing the level of integration, stable communication is obtained because all the communication circuits and the antennas are placed at locations where the communication circuit and the antenna are less likely to come under the influence of the electromagnetic wave noise leaked from the openings.

### MODIFIED EXAMPLE

Next, a wireless communication device 50a according to a modified example of the foregoing embodiment is described.

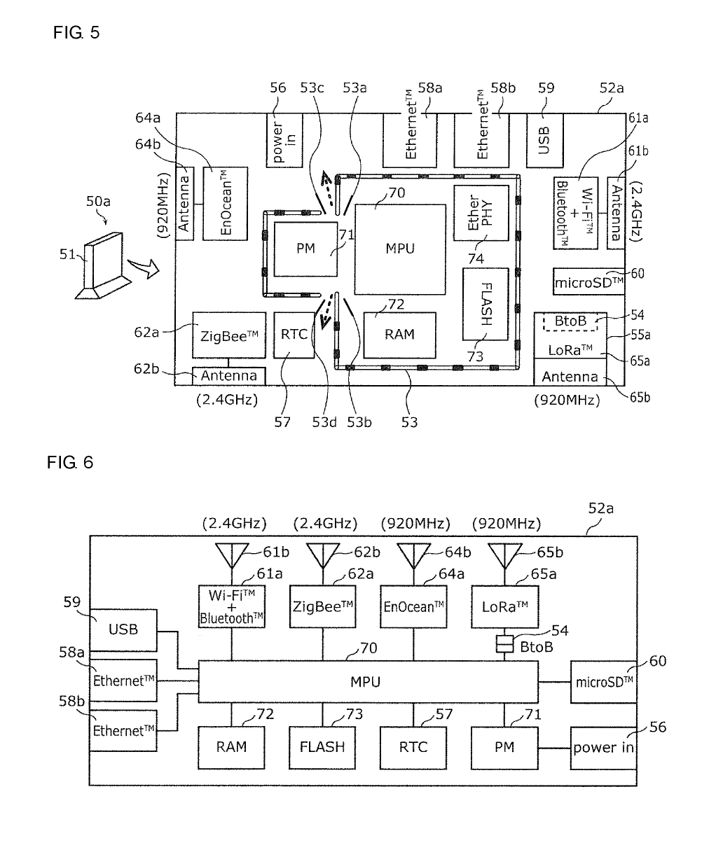

FIG. 5 is a diagram illustrating a configuration of the wireless communication device 50a according to the modified example of the embodiment. Here, the mounting layout of circuit boards (first board 52a and second board 55a) placed inside the housing 51 of the wireless communication device 50a is illustrated. FIG. 6 is a block diagram illustrating a connection relationship between various circuit elements mounted on the first board 52a and the second board 55a illustrated in FIG. 5.

In the present modified example, unlike the foregoing embodiment, a USB port 59 is mounted on the first board 52a, and on the second board 55a, a different third communication circuit 65a and third antenna 65b compatible with wireless communication system LoRa (Registered trademark) are mounted in place of Wi-SUN (Registered trademark), which serves as the third wireless communication system in the foregoing embodiment. In the following description, constituting elements identical to those in the foregoing embodiment are given the same reference numerals, and their descriptions are omitted. The descriptions regarding constituting elements different from the foregoing embodiment are provided below.

The USB port 59 is placed outside the housing 51 and is one example of an external device connector for connecting the wireless communication device 50a and an external device (namely, a communication circuit and an antenna) that performs wireless communication based on a wireless communication system different from any of the wireless communication systems (first wireless communication system (Wi-Fi (Registered trademark) and Bluetooth (Registered trademark)), second wireless communication system (ZigBee (Registered trademark)), third wireless communication system (LoRa (Registered trademark)), and fourth wireless communication system (EnOcean (Registered trademark))) used by the wireless communication device 50a. External devices to be connected to the USB port 59 include a 3G/LTE dongle, for example. Because of this, it becomes possible to perform wireless communication based on a newly added wireless communication system that is different from the wireless communication systems employed in the wireless communication device 50a.

Here, as illustrated in FIG. 5, the USB port 59 is placed along a side of the first board 52a (namely, the upper side) that is different from any sides of the first board 52a along which the antennas included in the wireless communication device 50a are placed (namely, the right-hand side of the first board 52a along which the first antenna 61b is placed, the bottom side of the first board 52a along which the second antenna 62b is placed, the bottom side of the first board 52a along which the third antenna 65b is placed, and the left-hand side of the first board 52a along which the fourth antenna 64b is placed).

Because of this, the USB port 59, which is for connecting with an external device (for example, 3G/LTE dongle) that performs wireless communication based on the wireless communication system that is different from the wireless communication systems employed in the wireless communication device 50a, is placed at the location where interference with wireless communication using any of the four antennas included in the wireless communication device 50a is less likely to occur, thereby enabling stable wireless communication by the external device that is added using the USB port 59.

Note that the communication circuit and the antenna (external devices) to be added are not limited to a dongle by USB and may be a card or the like, which is connected to its own unique connector, Secure Digital Input/Output (SDIO), or the like.

On the second board 55a of the present modified example, the third communication circuit 65a and the third antenna 65b that perform wireless communication based on LoRa (Registered trademark), which is another example of the third wireless communication system that uses the 920 MHz band, are mounted so as to be compatible in the delivery destination where LoRa (Registered trademark) is employed as a wireless communication system in smart grid.

In this way, the second board 55a on which the third communication circuit 65a and the third antenna 65b are placed is connected to the first board 52a using the board joining connector 54. Thus, by replacing the second board 55a with a type of board suitable in the delivery destination of the wireless communication device 50a, the wireless communication device 50a that meets the specifications of the delivery destination can be manufactured without difficulty.

Note that, depending on the delivery destination of the wireless communication device 50a, a communication circuit and an antenna that perform wireless communication based on Sigfox (Registered trademark), which is another example of the third wireless communication system that uses the 800/900 MHz band, may be mounted as the communication circuit and the antenna mounted on the second board 55a.

Thus far, the wireless communication devices of the present disclosure are described based on the embodiments and modified examples. However, the present disclosure is not limited to these embodiments and the modified examples. Embodiments obtained by applying various modifications apparent to those skilled in the art to the embodiments and the modified examples and different embodiments formed by combining parts of constituting elements of the embodiments and the modified examples are included in the scope of the present disclosure so long as they do not depart from the gist of the present disclosure.

For example, in the embodiments and the modified examples described above, a plurality of different wireless communication systems are employed for each of two frequency bands (2.4 GHz band and 800/900 MHz band). However, embodiments are not limited to such combinations and only need to employ a plurality of different wireless communication systems in at least one of frequency bands. For example, two different wireless communication systems that use the 2.4 GHz band may be employed, or two different wireless communication systems that use the 2.4 GHz band and one wireless communication system that uses the 800/900 MHz band may be employed.

Further, the frequency bands to be used in wireless communication are not limited to the 2.4 GHz band and the 800/900 MHz band, and a different frequency band such as the 5 GHz band or the like may also be used. For example, the first communication circuit 61a and the first antenna 61b may be compatible with Wi-Fi (Registered trademark) that uses the 2.4 GHz band and the 5 GHz band and Bluetooth (Registered trademark) that uses the 2.4 GHz band.

In the embodiments and the modified examples described above, the shapes (plane shape) of the first boards 52 and 52a are rectangular. However, the shapes of the first boards 52 and 52a are not limited to such shape and may be various types of polygon such as a circle, an oval, a hexagon, and the like, an L-shape, a recessed shape, a protruded shape, a shape obtained by clipping part of these, or various types of different shapes obtained by combining these.

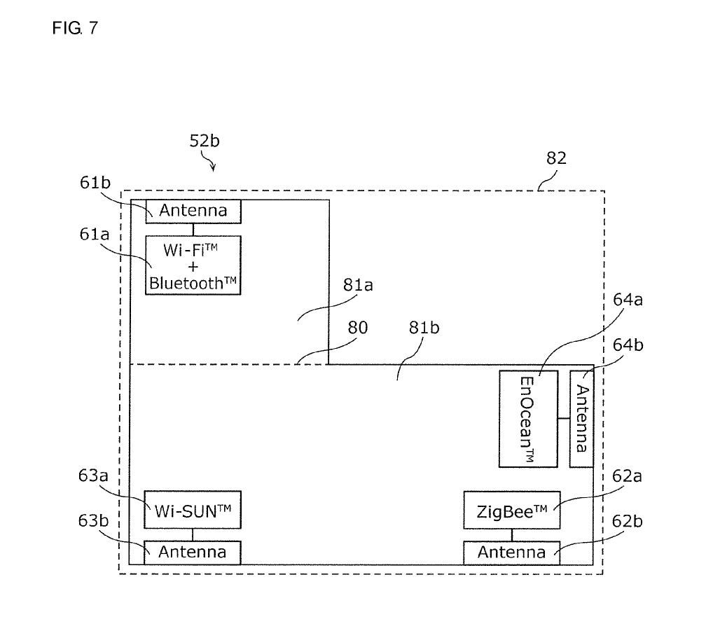

FIG. 7 is a diagram illustrating a mounting example of a communication circuit and an antenna in a first board 52b having an L-shape. In this drawing, for the sake of simplicity of illustration, only mounting locations of four sets of communication circuits and antennas (first communication circuit 61a and first antenna 61b, second communication circuit 62a and second antenna 62b, third communication circuit 63a and third antenna 63b, fourth communication circuit 64a and fourth antenna 64b) are illustrated.

Even in this case, it can be said that the first antenna 61b and the second antenna 62b are respectively placed in the first region and the second region that are in the diagonal spatial relationship in plan view of the first board 52b. This is because the first antenna 61b and the second antenna 62b are placed in the regions that are in the diagonal spatial relationship in a circumscribed rectangular region 82 of this L-shaped first board 52b.

It can be said that the third antenna 63b and the fourth antenna 64b are also respectively placed in the third region and the fourth region that are in the diagonal spatial relationship in plan view of the first board 52b. This is because the third antenna 63b and the fourth antenna 64b are placed in the regions that are in the diagonal spatial relationship in one (rectangular region 81b) of two rectangular regions 81a and 81b obtained by dividing this L-shaped first board 52b with a partition line 80.

In this way, “regions that are in the diagonal spatial relationship in plan view of the first board” include not only the regions that are in the diagonal spatial relationship when the first board is a rectangular shape, but also include the regions that are in the diagonal spatial relationship in the circumscribed rectangular region of the first board, and the regions that are in the diagonal spatial relationship in the rectangular region obtained by dividing the first board into a plurality of rectangular regions.

Note that, according to the first board 52b illustrated in FIG. 7, the first communication circuit 61a and the first antenna 61b are mounted on the rectangular region 81a that is different from the rectangular region 81b on which other three types of the communication circuits and the antennas are mounted, wherein the first communication circuit 61a and the first antenna 61b perform wireless communication by Wi-Fi (Registered trademark), which use the widest frequency band in the communication circuits and antennas mounted on the first board 52b or perform most frequent communication in the communication circuits and antennas mounted on the first board 52b. Because of this, in-band interference and out-of-band interference are suppressed between the first communication circuit 61a and the first antenna 61b, which perform wireless communication using large bandwidth or perform wireless communication highly frequently, and the other three types of communication circuits and antennas.

The present disclosure can be used as wireless communication devices or more specifically as devices that perform wireless communication based on a plurality of different wireless communication systems that use the same frequency band, and, for example, as a gateway or a device controller that controls devices by performing wireless communication with various devices such as a lighting apparatus, an illuminance sensor, a light switch, a smart meter, a smartphone, a PC, and the like.

12a, 12b Lighting apparatus

14 Illuminance sensor

22a, 22b Light switch

32a Smart meter

32b HEMS controller

42 Personal computer (PC)

44 Smartphone

50, 50a Wireless communication device

51 Housing

52, 52a, 52b First board

Shield case

53a, 53b Interior angle larger than 180 degrees

53c, 53d Opening

Board joining connector

55, 55a Second board

56 Electric power supply terminal

57 Real time clock

58a, 58b Ethernet (Registered trademark) port

59 USB port

60 microSD (Registered trademark)

61a First communication circuit

61b First antenna

62a Second communication circuit

62b Second antenna

63a, 65a Third communication circuit

63b, 65b Third antenna

64a Fourth communication circuit

64b Fourth antenna

70 MPU

71 Electric power management IC

72 RAM

73 Flash memory

74 Ethernet (Registered trademark) IC

80 Partition line

81a, 81b Rectangular region

Circumscribed rectangular region

1. A wireless communication device comprising:
a housing;
a first board placed inside the housing; and
a first communication circuit, a first antenna, a second communication circuit and a second antenna each mounted on the first board, wherein
the first communication circuit and the first antenna perform wireless communication based on a first wireless communication system using a first frequency band, and the second communication circuit and the second antenna perform wireless communication based on a second wireless communication system using the first frequency band, the second wireless communication system being different from the first wireless communication system, and
the first antenna and the second antenna are respectively placed in a first region and a second region, wherein the first region the second region are in a diagonal spatial relationship in a plan view of the first board.

2. The wireless communication device according to claim 1, wherein
the first antenna and the second antenna are arranged on the first board in such a way that principal radiation directions of the first antenna and the second antenna are orthogonal to each other.

3. The wireless communication device according to claim 1, further comprising a third communication circuit, a third antenna, a fourth communication circuit and a fourth antenna each mounted on the first board, wherein
the third communication circuit and the third antenna perform wireless communication based on a third wireless communication system using a second frequency band, the second frequency band being different from the first frequency band, and the fourth communication circuit and the fourth antenna perform wireless communication based on a fourth wireless communication system using the second frequency band, the fourth wireless communication system being different from the third wireless communication system, and
the third antenna and the fourth antenna are respectively arranged in a third region and a fourth region, wherein the third region and the fourth region are in a diagonal spatial relationship in a plan view of the first board, each of the third region and the fourth region being different from both the first region and the second region.

4. The wireless communication device according to claim 3, wherein
the third antenna and the fourth antenna are arranged on the first board in such a way that principal radiation directions of the third antenna and the fourth antenna are orthogonal to each other.

5. The wireless communication device according to claim 3, wherein
among communication circuits and antennas mounted on the first board, the first communication circuit and the first antenna perform communication using a widest frequency band or perform communication most frequently, and
among the communication circuits and the antennas mounted on the first board, the third communication circuit and the third antenna are mounted at a location closest to the first communication circuit and the first antenna and arranged on a second plane having a height from the first board different from a height of a first plane on which the first communication circuit and the first antenna are mounted.

6. The wireless communication device according to claim 5, further comprising a second board connected to the first board using a board joining connector, wherein
the first plane is a principal surface of the first board, and
the second plane is a principal surface of the second board.

7. The wireless communication device according to claim 6, wherein
the third wireless communication system is a wireless communication system of a type in which a frequency band to be used or a wireless communication system to be used or both are different depending on a delivery destination of the wireless communication device.

8. The wireless communication device according to claim 1, further comprising an electric power supply circuit, a logic circuit, and a shield case housing at least one of the electric power supply circuit and the logic circuit therein,
wherein each of the electric power supply circuit, the logic circuit and the shield case is further mounted on the first board,
the shield case has a contour including an interior angle larger than 180 degrees in a plan view of the first board,
an opening is provided at a side surface corresponding to the interior angle of the shield case, and
each of the first communication circuit, the first antenna, the second communication circuit, and the second antenna is arranged on the first board at such a location that is out of sight when viewed outside through the opening from inside of the shield case.

9. The wireless communication device according to claim 1, wherein
the first antenna and the second antenna are arranged along a side of the first board in a plan view of the first board,
an external device connector for connecting the wireless communication device and an external device is further mounted on the first board, the external device being placed outside the housing and performing wireless communication based on a wireless communication system different from both the first wireless communication system and the second wireless communication system, and
the external device connector is arranged along a side of the first board different from both the side of the first board along which the first antenna is arranged and the side of the first board along which the second antenna is arranged.

10. The wireless communication device according to claim 2, further comprising a third communication circuit, a third antenna, a fourth communication circuit and a fourth antenna each mounted on the first board, wherein
the third communication circuit and the third antenna perform wireless communication based on a third wireless communication system using a second frequency band, the second frequency band being different from the first frequency band, and the fourth communication circuit and the fourth antenna perform wireless communication based on a fourth wireless communication system using the second frequency band, the fourth wireless communication system being different from the third wireless communication system, and
the third antenna and the fourth antenna are respectively arranged in a third region and a fourth region, wherein the third region and the fourth region are in a diagonal spatial relationship in a plan view of the first board, each of the third region and the fourth region being different from both the first region and the second region.

11. The wireless communication device according to claim 4, wherein
among communication circuits and antennas mounted on the first board, the first communication circuit and the first antenna perform communication using a widest frequency band or perform communication most frequently, and
among the communication circuits and the antennas mounted on the first board, the third communication circuit and the third antenna are mounted at a location closest to the first communication circuit and the first antenna and arranged on a second plane having a height from the first board different from a height of a first plane on which the first communication circuit and the first antenna are mounted.

12. The wireless communication device according to claim 2, further comprising an electric power supply circuit, a logic circuit, and a shield case housing at least one of the electric power supply circuit and the logic circuit therein,
wherein each of the electric power supply circuit, the logic circuit and the shield case is further mounted on the first board,
the shield case has a contour including an interior angle larger than 180 degrees in a plan view of the first board,
an opening is provided at a side surface corresponding to the interior angle of the shield case, and
each of the first communication circuit, the first antenna, the second communication circuit, and the second antenna is arranged on the first board at such a location that is out of sight when viewed outside through the opening from inside of the shield case.

13. The wireless communication device according to claim 2, wherein
the first antenna and the second antenna are arranged along a side of the first board in a plan view of the first board,
an external device connector for connecting the wireless communication device and an external device is further mounted on the first board, the external device being placed outside the housing and performing wireless communication based on a wireless communication system different from both the first wireless communication system and the second wireless communication system, and
the external device connector is arranged along a side of the first board different from both the side of the first board along which the first antenna is arranged and the side of the first board along which the second antenna is arranged.
